(19) United States
(12) Patent Application Publication
(10) Pub. No.: US 2007/0123609 A1
(43) Pub. Date: May 31, 2007

(54) Coating and prevention of sticking of marine life and method for preparation thereof

(76) Inventor: Sanai Fujita, Saitama (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/584,432

(22) PCT Filed: Feb. 17, 2005
(86) PCT No.: PCT/JP05/02969

§ 371 Date: Jun. 22, 2006

(30) Foreign Application Priority Data
Feb. 24, 2004 (JP) 2004-048102

(51) Int. Cl. C09J 4/00

(52) U.S. Cl. 523/177; 523/210

(57) ABSTRACT

A coating for preventing the sticking of marine lives which comprises 100 parts by weight of a main agent containing a modified epoxy resin and, as a filler to the resin, a silicon dioxide powder impregnated with a mixed solution obtained by dissolving a calcined animal bone powder into a liquid mixture of sulfamic acid and boric acid, and 20 to 30 parts by weight of a curing agent for the above modified epoxy resin; and a method for preparing the coating. The application of a coating material formed by mixing the main agent and the curing agent onto a required portion and the formation of a coating film allows the prevention of the sticking of marine lives onto a ship body, a structure in the sea, a pipe line for receiving or discharging sea water, a port facilities and the like.

### BACKGROUND OF THE INVENTION

1. Technical Field

The present invention relates to an underwater coating into which calcined animal bone powder and an inorganic acid have been mixed, and relates in particular to a coating that prevents marine lives, such as, mollusks, barnacles, weeds and algae, from sticking to the surfaces of objects to be coated, and a preparation method thereof.

2. Background Art

Various marine lives, such as multiple kinds of snails, oysters, barnacles, weeds and algae, tend to attach themselves to the hulls of ocean going vessels, bridge pilings constructed of steel or ferro concrete steel, docks and undersea structures, harbor installations like marker buoys, light buoys and other navigational aids, the intake/discharge pipes of steam condenser cooling water systems for thermal power plants and nuclear power plants, and underwater portions of other structures built over the sea.

When marine organisms become attached to a ship's bottom, the surface is no longer smooth, and not only is underwater resistance while under way increased and the sailing speed reduced, but there is also a considerable increase in fuel consumption. Further, when many marine organisms are attached to the internal wall of an intake/discharge pipe for the cooling water system of a steam power plant or a nuclear power plant that employs a condensing turbine, the functioning of the steam condenser is deteriorated and the output of the power plant is accordingly reduced, definitely not a preferable condition for the promotion of energy conservation.

Furthermore, when many marine organisms are attached to various types of harbor installations, such as break waters, wave-dissipating concrete blocks and navigational aids, bridge pilings and other structures normally underwater, and the submerged foundations of structures constructed over the sea, at low tide this can detract from the beauty of a tourist location, and in an extreme case, may shorten the life of a structure while adversely affecting the structure's intended function.

To remove such marine organisms growing on the bottoms of vessels, on the internal walls of intake/discharge pipes and on other structures, a great deal of money and time are required, and the materials of the structures can be damaged. Therefore, means is in demand for preventing, to the extent possible, encrustation by marine organisms. For example, to prevent marine organisms from encrusting the bottoms of vessels, a special coating containing organic tin has been widely employed in many countries.

However, since organic tin dissolves in ocean water and adversely affects the ecosystem, i.e., may be the cause of a so-called incretion nuisance chemical substance (an environmental hormone), the use of this material is not preferable, and internationally, it is advocated that organic tin not be employed. Another means is known whereby a silicon coating is applied to provide a smooth coating surface that will prevent encrustation by marine organisms. However, this is effective for only a short period of time, and thus is insufficiently durable.

As a so-called corrosion protection coating for depositing a physically and chemically stable protective film on the surface of an object immersed in seawater, a coating wherein a curing agent has been added to an epoxy resin, a base material, is widely employed. It is known that a coating containing an epoxy resin as its main agent is an appropriate corrosion protection coating that is superior in adhesion, water resistance, chemical resistance and mechanical strength, and many conventional examples have been disclosed.

For example, in Japanese Patent Laid-Open Publication No. Hei 6-287276, an aqueous epoxy resin composition is disclosed. For this composition, polyfunctional epoxy resin is employed as the main agent, and a compound that is obtained by modifying, using an epoxy resin, polyamideamine, which consists of a polyamine and polyethyleneoxide having a carboxyl group, is employed as a curing agent. And a mixture of the main agent and the curing agent is employed as an aqueous dispersing agent. Furthermore, according to Japanese Patent Laid-Open Publication No. Hei 7-309929, a carboxyl group of a polyester resin, which has two or more carboxyl groups in a molecule obtained by a reaction between polyhydric alcohol, having a polyoxyethylene chain, and polycarboxylic acid or acid anhydride thereof, reacts with the epoxy group of an epoxy resin. The thus obtained epoxy resin is superior in water resistance, and when a polyamideamine curing agent or another curing agent is employed with a solution of this epoxy resin, a superior water resistant coating is obtained. In addition, according to Japanese Patent Laid-Open Publication No. 2001-335740, a main agent wherein calcined animal bone powder is added as a filler to a modified epoxy resin is employed, while modified aliphatic polyamine or polyamideamine is used as a curing agent, so that a superior water resistant coating for preventing encrustation by microorganisms is disclosed. As for the conventional techniques, there is a demand for the development of a coating for preventing, to the extent possible, the encrustation by marine organisms of the surfaces of vessel bottoms, the intake/discharge pipes of cooling water systems and bridge pilings and other under water structures. However, the provision of satisfactory effects for an extended period of time have not been achieved.

The objective of the present invention is to provide a coating for preventing the sticking of marine lives for forming a surface coating that can effectively prevent encrustation by marine lives, and a preparation method thereof.

### DISCLOSURE OF THE INVENTION

The present invention provides a coating for prevention of sticking of marine lives comprising:

100 parts by weight of a main agent that contains a modified epoxy resin and, as a filler, silicon dioxide (SiO₂) powder that is impregnated with a mixed solution obtained by dissolving calcined animal bone powder (apatite) in a liquid mixture of sulfamic acid and boric acid; and

20 to 30 parts by weight of a curing agent relative to the modified epoxy resin. The epoxy resin of this invention can be a liquid epoxy resin of bisphenol A and/or a liquid epoxy resin of bisphenol F. Further, instead of an epoxy resin, a silicon resin, a urethane resin or a nylon resin can also be employed. The calcined animal bone powder (apatite), which is impregnated with silicon dioxide (silica) powder that is filled in the epoxy resin, can be obtained by boiling raw animal bones, such as cattle bones, calcining the bones at around 900° C. to 1100° C., and then, pulverizing the calcined bones.

The thus obtained animal bone powder is added to the liquid mixture of 70 parts by weight of sulfamic acid and 1 to 3 parts by weight of boric acid, which is heated to about 80° C. to 100° C., and is agitated for about ten to thirty minutes. The thus prepared mixed solution is impregnated with silicon dioxide and is dried using warm air, or naturally, and the main agent of a coating is obtained. The mixing ratio of the mixed solution, wherein animal bone powder is dissolved, relative to silicon dioxide is about 100 to 90, 90 to 100, or 100 to 100. Further, the curing agent can be modified aliphatic polyamine and/or polyamideamine, and 10 to 40 parts by weight of the curing agent, preferably, 20 to 30 parts by weight, is mixed with 100 parts by weight of the main agent of the coating.

The coating of this invention can be employed as a two-liquid mix coating that includes: a main agent, which contains the modified epoxy resin and, as a filler, silicon dioxide powder that is impregnated with a mixed solution that is obtained by mixing calcined animal bones with a liquid mixture of sulfamic acid and boric acid, and a curing agent, such as modified aliphatic polyamine and/or polyamideamine. Instead of sulfamic acid, an inorganic acid, such as sulfuric acid, hydrochloric acid or nitric acid, can be employed. For silicon dioxide powder, which is contained as a filler in the main agent of the coating of the invention, 70 parts by weight of sulfamic acid and 1 to 3 parts by weight of boric acid are mixed and heated to about 80° C. to 100° C. Then, about 10 to 40 parts of calcined animal bone powder is added to the thus prepared mixed solution, and is sufficiently agitated. The resultant liquid mixture is then impregnated with silicon dioxide and dried. It should be noted that sulfamic acid is a strong acid that has a pH of 1 to 2, and that calcined animal bone powder has a pH of 10 to 11.

According to the coating of the invention, since silicon dioxide powder is contained in the main agent, water resistance, adhesion and surface hardness are improved, and since calcined animal bone powder mixed with sulfamic acid, which is a strong inorganic acid, is also included, the sticking of marine organisms can be effectively prevented. Therefore, when the coating of this invention is applied, for example, to vessel bottoms, to the inside of feeding/delivery pipes and the water intake/discharge equipment of steam condenser cooling systems for steam power plants and nuclear power plants, sticking by various marine lives, such as barnacles, weeds and algae, can be considerably impeded for an extended period of time. When this coating is applied to the surfaces of bridge pilings, harbor facilities, wave-dissipating concrete blocks and foundation portions of structures constructed over the sea, the same effects can be expected.

When a coating of this invention is to be employed, the main agent and the curing agent are blended at the predetermined ratio described above and are sufficiently and evenly agitated, and the coating is applied to the object in the same manner as is normal coating. Especially in order to increase durability, multiple layers, such as an undercoat, a second coat and a top coat, can be applied to form a coating. In this manner, a strong and effective coating that can prevent marine lives encrustation can be provided.

The use of brushes or rollers is appropriate for the application of a coating of this invention because of the affect of the grain sizes of the silicon dioxide powder and the impregnated animal bone powder, and because the viscosity is increased after the main agent and the curing agent have been mixed. When an air gun is employed to apply a coating of this invention, a curing retarder, such as toluene or xylene, may be mixed in, as needed, to adjust the curing speed.

### BEST MODE FOR CARRYING OUT THE INVENTION

An explanation will now be given for a method used to prepare silicon dioxide to be added, as a filler, to the main agent of a coating according to the present invention. It should be noted, however, that the technical scope of the invention is not limited to the following embodiment so long as the intended use does not depart from the spirit and the scope of the present invention.

About 100 to 400 mesh is an appropriate grain size for calcined animal bone powder that is to be added, as a filler, to a main agent that employs an epoxy resin as a primary element. For uniform filling, such fine animal bone powder must be mixed with and dissolved in sulfamic acid, which is a strong inorganic acid. A liquid mixture, consisting of 70 parts by weight of sulfamic acid, which is diluted by water to obtain a pH of about 2, and 1 to 3 parts by weight of boric acid, is heated to a temperature of 80° C. to 100° C. Then, calcined animal bone powder is mixed in, little by little, and dissolved in the liquid mixture.

Following this, the liquid mixture of sulfamic acid and boric acid, wherein calcined animal bone powder has been dissolved, is impregnated with silicon dioxide, and thereafter, water and other volatile elements are removed either by warm-air drying or by natural drying. The silicon dioxide powder thus obtained is added as a filler to the epoxy resin, which is agitated to equally disperse the powder. The mixture thus obtained is the main agent. As described above, in this case, the liquid epoxy resin can be a liquid epoxy resin of bisphenol A and/or a liquid epoxy resin of bisphenol F.

For the animal bone powder used in this invention, animal bones that conventionally are mostly discarded at slaughterhouses and are generally troublesome to handle, but especially the dense, hard bones of cows, horses and sheep, are employed, and in this embodiment, raw bones are employed. These bones are processed as follows. First, the bones are cut into convenient sizes for calcination, and the cut bones are then boiled and calcined at around 900° C. to 1100° C. When elements other than those of bones, i.e., organic substances, such as gelatin, fat, protein and glue, remain in or attached to the bones, oxidized decay will result, so these substances must be completely removed. During the boiling process, organic substances are separated not only from the external wall of a bone, but also most organic substances are removed from inside pores in the bone. Thereafter, since the calcination process is performed, any remaining organic substances can be completely removed. At the same time, by lowering the humidity factor (water) of the bone until it is equal to or less than several %, preferably, almost 0%, the calcined animal bone is obtained. This is so-called apatite.

According to the calcination condition, the bone is completely bleached, but retains the initial texture state that includes an infinite number of pores. After the bone is cooled, the bone is pulverized. The bone powder generated in this manner provides a yield of about 40 weight % relative to the unprocessed bone, the raw material. The grains are composed of calcium (about 33 weight %), which is the main element, phosphorus (about 16.7 weight %), barium (about 1.03 weight %), sodium (about 0.76 weight %), sulfur (about 0.64 weight %), magnesium, potassium, chlorine, amine and iron. In the grains, an infinite number of fine pores communicate with each other, and these grains are alkaline and demonstrate an ion exchange function.

The curing agent for the epoxy resin can, for example, be a modified aliphatic polyamine or polyamideamine.

Before the main agent and the curing agent are to be used, the main agent and the curing agent are mixed, and sufficiently agitated, at a ratio of 20 to 30 parts by weight of the curing agent to 100 parts by weight of the main agent, while taking into account the amount of the main agent and the curing agent that can be used up during a 30 to 40 minutes processing period. Then, the anticipated coating according to this invention is obtained. The durability of this coating is improved because of the silicon dioxide, added as a filler to the main agent, and the calcined animal bone powder. Further, the antifouling effect lasts for an extended period of time because of the acid element contained in the main agent.

Furthermore, because of the characteristic of the epoxy resin composing the main agent, the presence of water on the surface of an object has little or no adverse affect. A coating can be applied in the presence of water, and in an extreme case, even underwater, and water trapped between the coating and the surface of the object will be discharged externally during the curing process, so that for a layer applied to the surface of the object, a satisfactory adhesiveness can be provided.

The following are specific examples of where the coating can be applied and the coating will effectively prevent, for example, an increase in resistance while vessels are under way and while water is being fed along water feed pipes, and will slow the deterioration of structural materials and maintain the beauty of spectacular views. These are merely examples, and the coating is not limited to these applications.

1. seawater using facilities: internal walls of seawater intake/discharge pipe lines for cooling steam condensers in, for example, steam power plants and nuclear power plants; floodgates, for blocking passage of tidal waves, and lock gates; and the seawater passages for facilities affiliated with the above described locations, aquariums, ocean leisure centers, salt manufacturing equipment, desalination apparatuses and seawater temperature difference power generation facilities

2. vessels and references: the hulls of large vessels, such as passenger liners, cargo ships and tankers; the external surfaces of ship chandlery and fishery tools; the bottoms and external surfaces of jetskis; and the hulls of fishing vessels, pleasure boats and yachts

3. harbor installations: navigation aids, such as marker buoys and light buoys; piers; seawalls; and wave-dissipating concrete blocks

4. foundation portions of undersea structures and structures constructed over the sea: bridge pilings; observation towers and viewing/sightseeing facilities; memorial structures; and the external surfaces of underwater observation facilities

In accordance with the intended uses or the purposes of the individual locations, the coating may be applied either to all portions of an object or, selectively, only to predetermined portions of an object, such as the underwater portion of the hull of a vessel, depending on the time, or a pipe line or a wall, a floor or a pillar of a structure that is constantly underwater. Furthermore, the thickness of a layer to be deposited, the times to apply coatings and the number of layers to be applied should be appropriately selected depending either on the purpose or on which purpose, preventing the deterioration of efficiency, maintaining the beauty of views, protecting the materials of structures and providing improved durability, is important.

As a characteristic of the epoxy resin, which is the base for the coating of the invention that contains animal bonepowder, a film that change is extremely strong and very adhesive is formed by interaction with the curing agent. Therefore, not only the antifouling function, but also a maintenance function for repairing broken portions of, or cracks or holes in an object to be coated can also be expected. Therefore, effects such as the prevention of water, oil or polluted water leaking from or flowing out of tanks, pipes and drainage grooves, for example, are exhibited.

### INDUSTRIAL APPLICABILITY

According to the coating for preventing the sticking of marine lives of the present invention, since the effects that prevent the sticking of marine lives are provided by the action of an acid that is slowly released from the coating, an increase in flow resistance, relative to sea currents, of a structure, such as the hull of a vessel or the inside of a seawater intake/discharge pipe, can be prevented. Furthermore, the sticking marine lives, for example, to an undersea structure or the foundation portion of a structure constructed over the sea can be prevented for an extended period of time, and great effects can be displayed in the maintenance of beautiful scenery and in the protection of construction materials.

1. A coating for prevention of sticking of marine lives comprising,
100 parts by weight of a main agent that contains a modified epoxy resin and, as a filler, silicon dioxide powder, which is impregnated with a mixed solution obtained by dissolving calcined animal bone powder in a liquid mixture of sulfamic acid and boric acid; and
20 to 30 parts by weight of a curing agent, relative to the modified epoxy resin.

2. A coating according to claim 1, wherein a mixing ratio for sulfamic acid and boric acid is 70 parts by weight of sulfamic acid to one to three parts by weight of boric acid.

3. A coating according to claim 1, wherein the animal bone powder is powder obtained by boiling cattle bones, which are raw animal bones, calcining the cattle bones at around 900° C. to 1100° C. and pulverizing the cattle bones that have been calcined.

4. A coating according to claim 1, wherein the epoxy resin is a liquid epoxy resin of bisphenol A and/or a liquid epoxy resin of bisphenol F.

5. A coating according to claim 1, wherein the curing agent for the main agent is modified aliphatic polyamine and/or polyamideamine.

6. A coating according to claim 1, which is a two-liquid mix type for which the main agent and the curing agent are to be mixed before coating is performed.

7. A method for preparing a coating for prevention of sticking of marine lives comprising the steps of:
mixing 10 to 40 parts by weight of animal bone powder with a liquid mixture wherein 1 to 3 parts by weight of boric acid has been added to 70 parts by weight of sulfamic acid, and dissolving the animal bone powder in the liquid mixture at a temperature of 80° C. to 100° C. for 10 to 30 minutes;
impregnating, with 100 parts by weight of silicon dioxide, 100 parts by weight of a mixed solution that has been obtained;
drying and pulverizing silicon dioxide impregnated with the mixed solution;
mixing and agitating 20 to 30 parts by weight of silicon dioxide, which has been dried and pulverized, with 100 parts by weight of a modified epoxy resin, and immediately before coating, blending 100 parts by weight of a coating main agent thus obtained with 20 to 30 parts by weight of a curing agent.

8. A coating according to claim 2, wherein the animal bone powder is powder obtained by boiling cattle bones, which are raw animal bones, calcining the cattle bones at around 900° C. to 1100° C. and pulverizing the cattle bones that have been calcined.

9. A coating according to claim 3, wherein the epoxy resin is a liquid epoxy resin of bisphenol A and/or a liquid epoxy resin of bisphenol F.

10. A coating according to claim 4, wherein the curing agent for the main agent is modified aliphatic polyamine and/or polyamideamine.
